(19) United States
(12) Patent Application Publication
(10) Pub. No.: US 2010/0139433 A1
(43) Pub. Date: Jun. 10, 2010

(54) Ball screw with a circulation member

(76) Inventors: Yan-Yu Chen, Taichung Industrial Park (TW); Michelle Wu, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/329,627

(22) Filed: Dec. 7, 2008

(51) Int. Cl. F16H 25/22; F16C 29/06

(52) U.S. Cl. 74/424.87

(57) ABSTRACT

A ball screw with a circulation member comprises: a screw, a nut, a circulation member, a plurality of rolling elements and a plurality of flexible members. The flexible members are disposed at the combining portion between the circulation member and the nut to allow them to be assembled closely, and to prevent the circulation member and the nut from being damaged when they are assembled and disassembled.

### BACKGROUND OF THE INVENTION

1. Field of the Invention

The present invention relates to a ball screw, and more particularly to a ball screw with a circulation member.

2. Description of the Prior Art

The ball screws used on various types of machines are generally divided into internal circulation type and external circulation type. For example, U.S. Pat. No. 4,953,419 discloses an external circulation type ball screw, the circulation member of which is a reverse U-shaped pipe. However, for weight reduction of the ball screw and smooth rolling of the balls, the circulation path inside the pipe is difficult to control due the machining of the reverse U-shaped pipe is not easy. Therefore, it is impossible for the balls to move smoothly.

Outer circulation type ball screw is essentially provided with a circulation member outside the screw for guiding the rolling balls out of the nut. With the circulation member, the circulation of the rolling balls can be realized. The present invention is aimed at the assembly relation between the circulation member and the ball screw.

The existing circulation members are mostly made of plastic. After a circulation member is assembled onto the ball screw, the plastic material of the circulation member plus the inherent manufacturing tolerance of the two will make the assembly clearance between the circulation member and the ball screw inconsistent, thus reducing the defective rate of the products. Therefore, a JP 2005-61608, as shown in FIG. 1, discloses a circulation member 11 which is defined in its leg portion 111 with a groove 112 for mating with a projection 122 of the nut 12, so as to assemble the circulation member 11 onto the nut 12. However, once the circulation member 11 is assembled onto the nut 12, the projection 122 cannot be disengaged from the groove 112. Therefore, it will not be easy to disassemble the circulation member 11 from the nut 12 when maintenance of the ball screw is required, or it might need to break the structure in order to disassemble the circulation member 11 from the nut 12. Such a design is likely to cause structural damage when maintenance is performed, increasing the maintenance cost. In addition, machining the projection 122 on the inner surface of the hole 121 of the nut 12 is cost intensive.

Then, a JP 2007-218383 discloses another circulation member 13, as shown in FIGS. 2 and 3, which is defined with a flange 132 around the leg portion 131 thereof, and the flange 132 is to be forced into the nut (not shown). However, when maintenance is performed by disassembling the circulation member 13 from the nut, the flange 132 will be damaged, which will affect the tightness between the circulation member and the nut when they are assembled again.

The present invention has arisen to mitigate and/or obviate the afore-described disadvantages.

### SUMMARY OF THE INVENTION

The primary object of the present invention is to provide a ball screw with a circulation member, wherein the flexible members are disposed at the combining portion between the circulation member and the nut to allow them to be assembled closely.

Another object of the present invention is to provide a ball screw with a circulation member, wherein the flexible members are disposed at the combining portion between the circulation member and the nut to prevent the circulation member and the nut from being damaged when they are assembled and disassembled.

The ball screw with a circulation member comprises a screw with a rolling groove in its outer surface, a nut having an inserting hole for insertion of the screw, in an inner surface of the inserting hole being formed a rolling groove for cooperating with the rolling groove of the screw to define loading path, in an outer surface of the nut being defined two through holes in communication with the rolling groove of the nut; a circulation member having two leg portions formed at both ends thereof and a circulation path defined between the two leg portions, the leg portions being inserted in the two through holes of the nut; a plurality of rolling elements rolling within the loading path and the circulation path; and a plurality of flexible members disposed between the leg portions of the circulation member and the inner surface of the through holes of the nut.

### BRIEF DESCRIPTION OF THE DRAWINGS

FIG. 1 is a cross sectional view of a conventional ball screw with a circulation member which is disclosed in JP 2005-61608;

FIG. 2 is a perspective view of a conventional ball screw with a circulation member which is disclosed in JP 2007-218383;

FIG. 3 is an amplified view of a part of FIG. 2;

FIG. 4 is an exploded view of a ball screw with a circulation member in accordance with a first embodiment of the present invention;

FIG. 5 is a perspective view of the ball screw with a circulation member in accordance with the first embodiment of the present invention;

FIG. 6 is a perspective view of a second embodiment of the present invention showing that the flexible members are disposed on the leg portions of the circulation member;

FIG. 7 is an exploded view of a circulation member in accordance with a third embodiment of the present invention;

FIG. 8 is a perspective view of the circulation member in accordance with the third embodiment of the present invention; and

FIG. 9 is a cross sectional view of a ball screw with a circulation member in accordance with the third embodiment of the present invention.

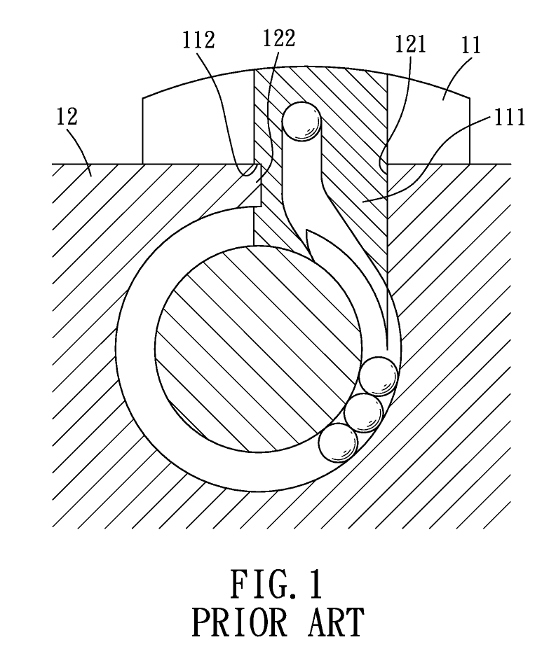

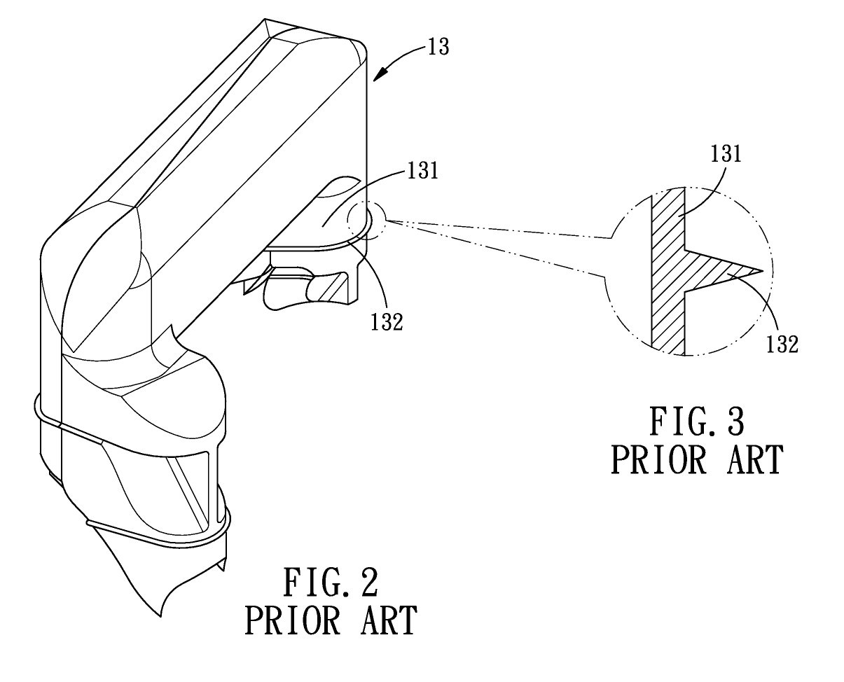

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

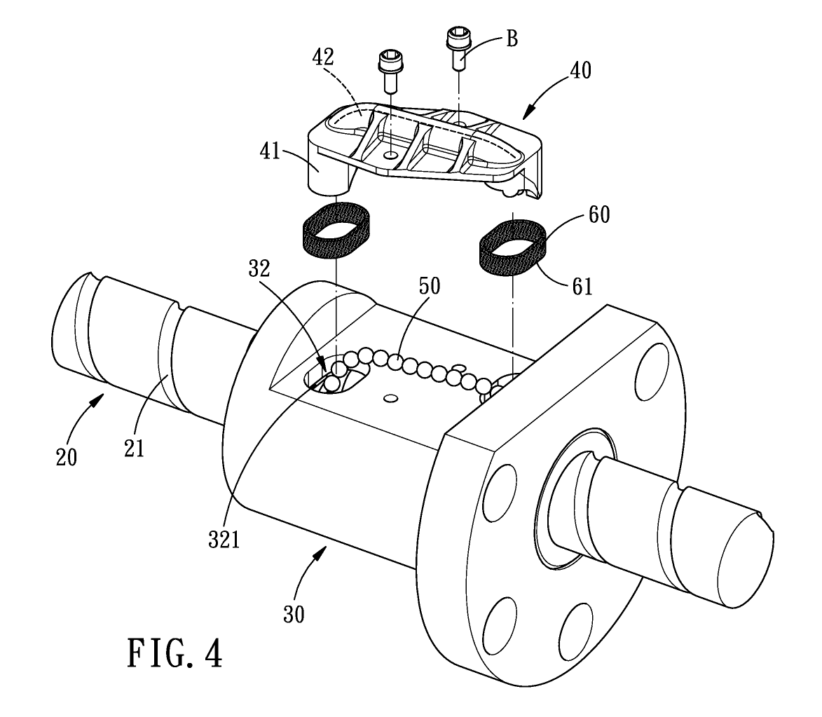

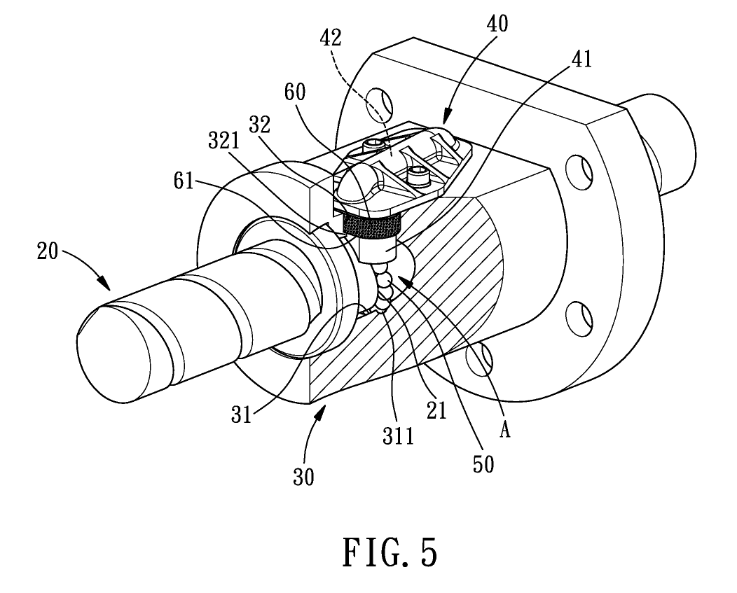

Referring to FIGS. 4 and 5, a ball screw with a circulation member in accordance with a first embodiment of the present invention comprises: a screw 20, a nut 30, a circulation member 40, a plurality of rolling elements 50 and two flexible members 60.

The screw 20 is defined in its outer surface with a rolling groove 21.

The nut 30 is provided with an inserting hole 31 for insertion of the screw 20, in the inner surface of the inserting hole 31 is defined a rolling groove 311 for cooperating with the rolling groove 21 to define a loading path A, in the outer surface of the nut 30 are defined two through holes 32 in communication with the rolling groove 311, and in each of the through holes 32 is defined an annular inner flange 321.

The circulation member 40 is made of resin and has a leg portion 41 at each of two ends thereof, and formed between the two leg portions 41 is a circulation path 42. The two leg portions 41 are to be inserted in the two holes 32, and the directions of the input and output portions of the circulation path 42 are tangent to the direction of the loading path A. The circulation member 40 is then fixed to the nut 30 by two screws B.

The plurality of rolling elements 50 roll within the loading path A and the circulation path 42.

The two flexible members 60 are ring-shaped and mounted to the leg portions 41 of the circulation member 40, respectively, and located between the leg portions 41 and the through holes 32 of the nut 30. Each of the flexible members 60 will be slightly deformed because of being pressed and squeezed by the legs 41 of the circulation member 40 and the inner surface of the inner flange 321 of the through holes 32 of the nut 30, and because its bottom surface 61 is abutted against the annular inner flange 321 of the through holes 32 of the nut 30.

It is understood from the above description of the structures of the main parts of the embodiment and the assembly relations among them that the first embodiment of the present invention has the following advantages:

1, Since the flexible members 60 are disposed between the legs portions 41 of the circulation members 40 and the inner surface of the through holes 32 of the nut 30, plus it is deformable, the circulation member 40 and the nut 30 can be assembled together more closely and tightly, creating a liquid-proof and anti-dust effect, namely, the oil inside the ball screw won't come out from the combining portion between the circulation members 40 and the nut 30, and foreign bodies from outside cannot enter the nut via this combining portion.

2, since the circulation member 40 and the nut 30 are assembled via the flexible and deformable members 60, in assembly, they can squeeze the flexible and deformable members 60 to make the assembly easier, similarly, will also make the disassembly easier, thus preventing the circulation member 40 and the nut 30 from being damaged when they are assembled and disassembled.

3, the flexibility and deformability of the flexible members 60 can absorb the shocks caused by the rolling elements 50 between the circulation member 40 and the nut 30, thus allowing the work platform of the processing machine carrying this ball screw to move more stably.

A ball screw with a circulation member in accordance with a second embodiment of the present invention also comprises: a screw, a nut, a circulation member, a plurality of rolling elements and two flexible members, and they generally are assembled in the same manner and provide the same function as the first embodiment, except the following differences:

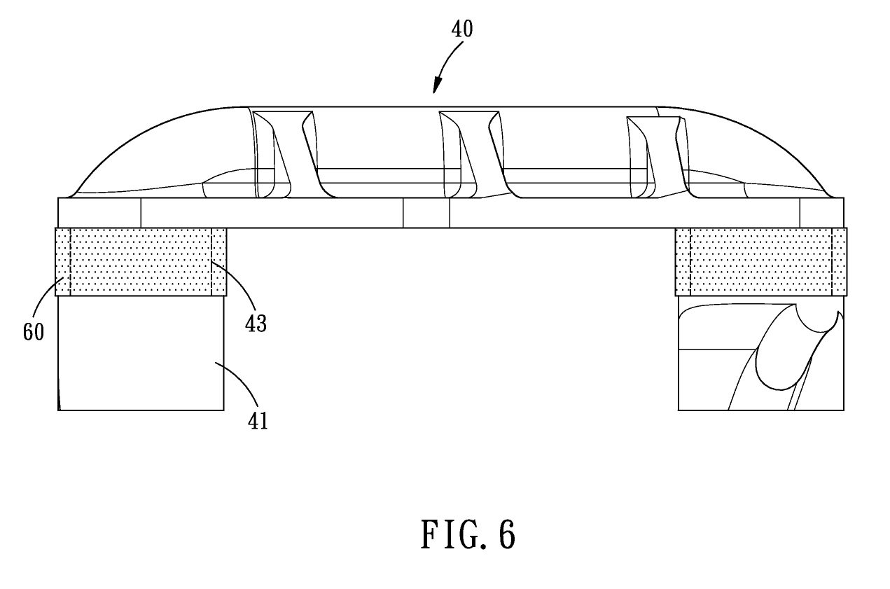

As shown in FIG. 6, in the outer surface of each of the leg portions 41 of the circulation member 40 is defined an annular groove 43, and the flexible members 60 are engaged in the annular grooves 43 of the circulation member 40 in such a manner that the flexible members 60 protrude a little out of the outer surface of the leg portions 41 after they are engaged in the annular grooves 43.

It is noted that since in the outer surface of each of the leg portions 41 of the circulation member 40 is defined the annular groove 43, which can further be used to control the thickness of the leg portions 41 of the circulation member 40 in addition to being provided for accommodation of the flexible members 60, so as to prevent the ununiformity of the contraction stress as a result of thickness difference of the leg portions 41, which will cause deformation of the circulation path 42 of the circulation member 40.

A ball screw with a circulation member in accordance with a third embodiment of the present invention comprises: a screw, a nut, a circulation member, a plurality of rolling elements and four flexible members. They generally are assembled in the same manner and provide the same function as the first embodiment, except the following differences:

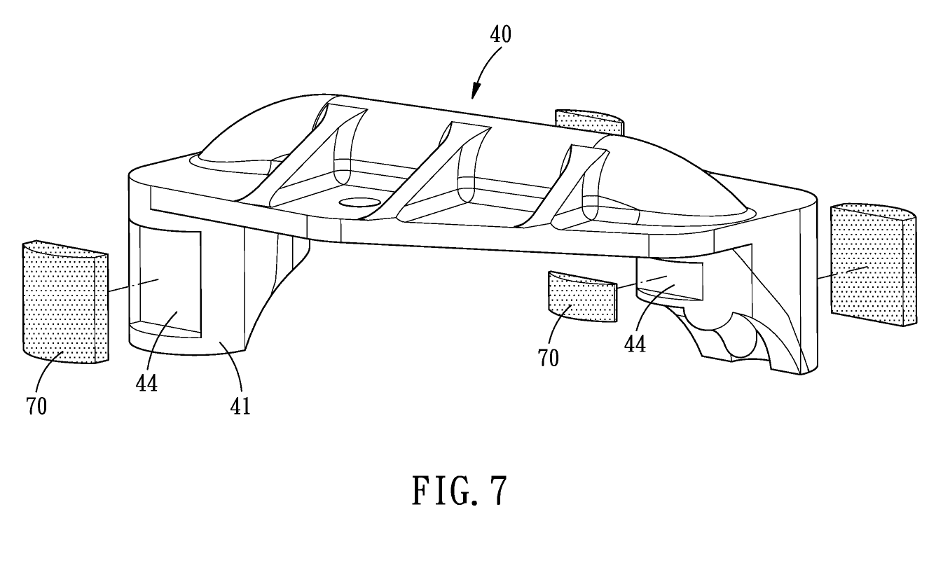

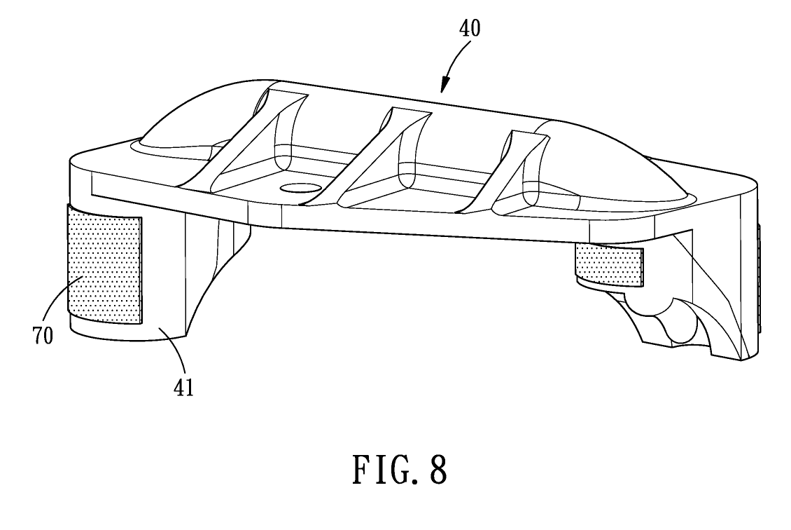

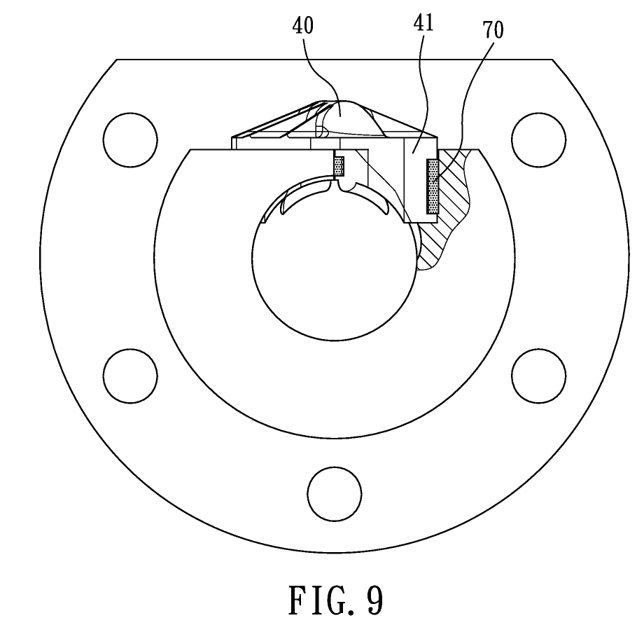

As shown in FIGS. 7-9, in the outer surface of each of the leg portions 41 of the circulation member 40 are defined opposite concaves 44.

The four flexible members 70 in the form of blocks are received in the concaves 44 in such a manner that the flexible members 70 protrude a little out of the outer surface of the leg portions 41 after they are engaged in the concaves 44.

It is noted that since in the outer surface of each of the leg portions 41 of the circulation member 40 are defined opposite concaves 44, which can further be used to control the thickness of the leg portions 41 of the circulation member 40 in addition to being provided for accommodation of the flexible members 60, so as to prevent the ununiformity of the contraction stress as a result of thickness difference of the leg portions 41, which will cause deformation of the circulation path 42 of the circulation member 40.

While we have shown and described various embodiments in accordance with the present invention, it is clear to those skilled in the art that further embodiments may be made without departing from the scope of the present invention.

What is claimed is:

1. A ball screw with a circulation member, comprising:
a screw with a rolling groove in its outer surface;
a nut having an inserting hole for insertion of the screw, in an inner surface of the inserting hole being formed a rolling groove for cooperating with the rolling groove of the screw to define loading path, in an outer surface of the nut being defined two through holes in communication with the rolling groove of the nut;
a circulation member having two leg portions formed at both ends thereof and a circulation path defined between the two leg portions, the leg portions being inserted in the two through holes of the nut;
a plurality of rolling elements rolling within the loading path and the circulation path; and
a plurality of flexible members disposed between the leg portions of the circulation member and the inner surface of the through holes of the nut.

2. The ball screw with a circulation member as claimed in claim 1, wherein the flexible members are ring-shaped and mounted on the leg portions of the circulation member.

3. The ball screw with a circulation member as claimed in claim 1, wherein each of the leg portions of the circulation member is defined with an annular groove in its outer surface for engaging with the flexible members.

4. The ball screw with a circulation member as claimed in claim 1, wherein each of the leg portions of the circulation member is defined with concaves for engaging with the flexible members.

5. The ball screw with a circulation member as claimed in claim 1, wherein each of the through holes is defined on its inner surface with an annular inner flange against which a bottom surface of the respective flexible members is abutted.

6. The ball screw with a circulation member as claimed in claim 1, wherein the circulation member is made resin.
